(19) United States
(12) Patent Application Publication
(10) Pub. No.: US 2017/0017341 A1
(43) Pub. Date: Jan. 19, 2017

(54) TOUCH DISPLAY PANEL

(71) Applicant: InnoLux Corporation, Miao-Li County (TW)

(72) Inventors: Bo-Feng CHEN, Miao-Li County (TW); Tung-Kai LIU, Miao-Li County (TW); Chih-Hao CHANG, Miao-Li County (TW); Chia-Hao TSAI, Miao-Li County (TW); Jen-Chieh PENG, Miao-Li County (TW)

(21) Appl. No.: 15/203,354

(22) Filed: Jul. 6, 2016

Related U.S. Application Data
(60) Provisional application No. 62/193,787, filed on Jul. 17, 2015.

(30) Foreign Application Priority Data
Feb. 3, 2016 (TW) 105103449

(51) Int. Cl. G06F 3/041; G06F 3/044

(52) U.S. Cl. CPC G06F 3/0416; G06F 3/0412; G06F 3/044; G06F 2203/04111

(57) ABSTRACT

A touch display panel includes common electrodes arranged along a first direction and a second direction, At least one common electrode having a first side and a second side parallel to the second direction, and metal wires extending parallel along the second direction. At least one common electrode is connected with one of the metal wires via at least a contact hole. The common electrodes include a first common electrode and a second common electrode that are adjacent in the first direction. The second side of the first common electrode is adjacent to the first side of the second electrode. The distance between the contact hole of the first common electrode and the second side of the first common electrode is equal to the distance between the contact hole of the second common electrode and the first side of the second common electrode.

### CROSS REFERENCE TO RELATED APPLICATIONS

This application claims the benefit of U.S. Provisional Application No. 62/193,787 filed on Jul. 17, 2015, the entirety of which is incorporated by reference herein.

This Application claims priority of Taiwan Patent Application No. 105103449, filed on Feb. 3, 2016, the entirety of which is incorporated by reference herein.

### BACKGROUND OF THE INVENTION

Field of the Invention

The disclosure relates to a touch display panel, and in particular to a touch display panel capable of reducing display mura.

Description of the Related Art

The touch display panel is a new type of display panel that integrates the display function and the touch function. In the touch display panel, the panel IC and the touch IC are integrated together. This panel is manufactured using a new process provided by the liquid-crystal panel manufacturer.

In one kind of touch display panel, the common electrode (also called the grounded electrode) is divided into a plurality of electrode blocks which are arranged in a matrix. Each electrode block is used as a normal common electrode in the display period and as a touch sensing electrode in the touch period. The position of a touch object is determined by detecting the capacitance formed between the touch sensing electrode and the touch object.

FIG. 1 is a top view of a conventional touch display panel. As shown in FIG. 1, each of common electrodes S1, S2, . . . , and Sn is connected to with one of metal wires T1, T2, . . . , and Tn via contact holes C. During the display period of the touch display panel, these metal wires T1, T2, . . . , and Tn output a predetermined voltage level so as to keep all of the common electrodes S1, S2, . . . , and Sn at the same voltage level. During the touch period of the touch display panel, the metal wires T1, T2, . . . , and Tn output touch sensing signals respectively to sense whether the common electrodes S1, S2, . . . , and Sn are touched or not. The touch sensing signals transmitted by the metal wires T1, T2, . . . , and Tn are shown in FIG. 2. The phase and amplitude of all of the touch sensing signals are the same. After the touch sensing signals reach the common electrodes S1, S2, . . . , and Sn, the touch position can be determined by detecting variations in at least one of the following values: capacitance, amount of electric charge, signal, charge time, etc.

The touch display panel is driven in the display period and the touch period to alternatively perform a display function and a touch function. FIG. 3 is a diagram showing the voltage waveform at a common electrode during the display period and the touch period. A common electrode is maintained at a predetermined voltage level Vcom during the display period P_{D} and driven to a high voltage level Vtouch for touch sensing during the touch period P_{T}. Note that the high voltage level Vtouch can be considered as the average voltage level of the multiple pulses shown in FIG. 2. Here, in order to focus on the variation of the voltage level at the boundary between the display period P_{D} and the touch period P_{T}, the small voltage variation at the common electrode during the touch period P_{T} is not depicted.

However, using a conventional metal-wire layout, regarding two adjacent electrodes, the distance between the contact hole and the edge of one common electrode is different from the distance between the contact hole and the edge of the other common electrode, so the resistance for a signal transmitted to the edge of two adjacent common electrodes is different.

FIG. 4A is an enlarged view of the two adjacent electrodes circled by the dotted line shown in FIG. 1. As shown in FIG. 4A, an electric current flows from bottom to top (along the arrow direction) to the common electrode S2 or Sm, and then flows toward the two sides of the same common electrode after reaching the contact hole. In the common electrode S2, the distance where the electric current flows from the contact hole C to the right side edge E1 is L1; in the common electrode Sm, the distance where the electric current flows from the contact hole C to the left side edge E2 is L2. The distance L1 is longer than the distance L2.

FIGS. 4B and 4C are two diagrams respectively showing the voltage waveform at an edge of one of the adjacent common electrodes during the display period and the touch period. FIG. 4B shows the signal waveform at the left side edge E2 shown in FIG. 4A. FIG. 4C shows the signal waveform at the right side edge E1 shown in FIG. 4A. Because the signal travels a relatively short distance to the left side edge E2 of the common electrode Sm, the resistance is relatively low. When the touch period P_{T} is switched to the display period P_{D}, the voltage level reaches the common voltage level Vcom fast and the signal distortion is low. On the other hand, because the signal travels a relatively long distance to the right side edge E1 of the common electrode S2, the resistance is relatively high. When the touch period P_{T} is switched to the display period P_{D}, the voltage level reaches the common voltage level Vcom slowly and the signal distortion is high. Therefore, the distortion degree of the common voltage level at the edges of the two adjacent common electrodes is inconsistent, which generates display mura at the boundary of the two adjacent common electrodes.

On the other side, the common electrodes are arranged in a matrix on the display area 11 of the substrate 10, and the driving chip IC which outputs the common voltage level and the touch sensing signals is arranged on the non-display area 12 outside of the display area 11. The conventional metal wire layout is shown in FIGS. 5A and 5B. The metal wires extend parallel to the column direction in the display area and converge in a fan shape toward the driving chip IC in the non-display area 12. Under the conventional layout, regarding the metal wires connecting with the common electrodes in a single column, the leftmost metal wire Tmax is connected to the topmost common electrode in the display area 11 and hence has a longest length in the display area 11. That metal wire Tmax is farthest to the driving chip IC in the non-display area 12, and also has the longest length in the non-display area 12. Regarding the metal wires connected with the common electrodes in the same column, the rightmost metal wire Tmin is connected to the bottommost common electrode in the display area 11 and hence has the shortest length in the display area 11. That metal wire Tmin is nearest to the driving chip IC in the non-display area 12, and also has the shortest length in the non-display area 12.

In this way, the RC loading of the longest metal wire Tmax is higher than the RC loading of the shortest metal wire Tmin. In the design stage, different metal wires have to meet the same requirements of RC loading specifications. Therefore, the conventional metal wire layout increases the design difficulty.

In view of the above problems, the disclosure provides a touch display panel capable of reducing display mura and RC loading of wires.

### BRIEF SUMMARY OF THE INVENTION

A detailed description is given in the following embodiments with reference to the accompanying drawings.

The disclosure provides a first touch display panel, including a substrate, a plurality of common electrodes, a driving chip, and a plurality of metal wires. The substrate has a display area and a non-display area that surrounds the display area. The common electrodes are arranged in the display area in a first direction and a second direction that is different from the first direction. The driving chip is arranged in the non-display area. The metal wires are connected to the common electrodes and the driving chip. The metal wires extend parallel to the second direction in the display area. At least one of the common electrodes has a first side and a second side parallel to the second direction. At least one of the common electrodes is connected with one of the metal wires via at least a contact hole. The common electrodes include a first common electrode and a second common electrode that is adjacent in the first direction, and both the first common electrode and the second common electrode have a first side and a second side that are parallel to the second direction. The second side of the first common electrode and the first side of the second common electrode are adjacent. The distance between the contact hole of the first common electrode and the second side of the first common electrode is equal to the distance between the contact hole of the second common electrode and the first side of the second common electrode.

According to an embodiment, in the first touch display panel: regarding the common electrodes having the same position in the first direction; the distance between any two adjacent metal wires is shorter than the distance between the metal wire nearest to the first side and the first side, and shorter than the distance between the metal wire nearest to the second side and the second side.

According to an embodiment, in the first touch display panel, regarding the common electrodes having the same position in the first direction, the distance between any two adjacent metal wires is shorter than half of the distance between the metal wire nearest to the first side and the first side, and shorter than half of the distance between the metal wire nearest to the second side and the second side.

According to an embodiment, in the first touch display panel, assuming that there are N of the metal wires connected to the common electrodes having the same position in the first direction, the distance between the metal wire nearest to the first side and the first side is La, the distance between the metal wire nearest to the second side and the second side is Lb, and the span width of the N metal wires in the first direction is Lc, the following equation is satisfied:

Lc/(N−1)<La;

and

Lc/(N−1)<Lb.

According to an embodiment, in the first touch display panel: regarding the metal wires connected to the common electrodes having the same position in the first direction; the one having longer length in the display area has a shorter length in the non-display area, and the one having a shorter length in the display area has a longer length in the non-display area.

According to an embodiment, in the first touch display panel, the first direction is one of the row direction and the column direction in a matrix, and the second direction is the other of the row direction and the column direction in the matrix.

The disclosure also provides a second touch display panel, including: a substrate having a display area and a non-display area surrounding the display area; a plurality of common electrodes arranged in the display area in a first direction and a second direction that is different from the first direction, at least one of the common electrodes having a first side and a second side parallel to the second direction; a driving chip arranged in the non-display area; and a plurality of metal wires connected to the common electrodes and the driving chip. The metal wires extend parallel to the second direction in the display area. At least one of the common electrodes is connected with one of the metal wires via at least a contact hole. Regarding the common electrodes having the same position in the first direction, a distance between any two adjacent metal wires is shorter than the distance between the metal wire nearest to the first side and the first side, and the distance between any two adjacent metal wires is shorter than the distance between the metal wire nearest to the second side and the second side.

According to an embodiment, in the second touch display panel: regarding the common electrodes having the same position in the first direction; the distance between any two adjacent metal wires is shorter than half of the distance between the metal wire nearest to the first side and the first side, and the distance between any two adjacent metal wires is shorter than half of the distance between the metal wire nearest to the second side and the second side.

According to an embodiment, in the second touch display panel: regarding the metal wires connected to the common electrodes having the same position in the first direction; the one having the longer length in the display area has a shorter length in the non-display area, and the one having the shorter length in the display area has a longer length in the non-display area.

According to an embodiment, in the second touch display panel; the first direction is either the row direction or the column direction in a matrix, and the second direction is the other of either the row direction or the column direction in the matrix

According to the first touch display panel or the second touch display panel, the display mura and RC loading of wires can be reduced.

### BRIEF DESCRIPTION OF THE DRAWINGS

The disclosure can be more fully understood by reading the subsequent detailed description and examples with references made to the accompanying drawings, wherein:

FIG. 1 is a top view of a conventional touch display panel;

FIG. 2 is a time chart of touch sensing signals sent by the metal wires shown in FIG. 1;

FIG. 3 is a diagram showing the voltage waveform at a common electrode during the display period and the touch period;

FIG. 4A is an enlarged view of the two adjacent electrodes circled by the dotted line shown in FIG. 1;

FIGS. 4B and 4C are two diagrams respectively showing the voltage waveform at an edge of one of the adjacent common electrodes during the display period and the touch period;

FIG. 5A is a diagram showing a conventional layout of metal wires in a touch display panel;

FIG. 5B is an enlarged view of the portion circled by the dotted line shown in FIG. 5A;

FIG. 6A is a diagram showing a layout of metal wires in a touch display panel in accordance with Embodiment 1;

FIGS. 6B-1 and 6B-2 are enlarged views of the portions circled by the dotted line shown in FIG. 6A;

FIG. 7A is a diagram showing a layout of metal wires in a touch display panel in accordance with Embodiment 2;

FIGS. 7B is an enlarged views of the portions circled by the dotted line shown in FIG. 7A;

FIG. 8 is a diagram showing a layout of metal wires in a touch display panel in accordance with Embodiment 3;

FIG. 9 is a diagram showing a layout of metal wires in a touch display panel in accordance with Embodiment 4;

FIG. 10 is a diagram showing a layout of metal wires in a touch display panel in accordance with Embodiment 5;

FIG. 11 is a diagram showing a layout of metal wires in a touch display panel in accordance with Embodiment 6; and

FIG. 12 is a diagram showing a layout of metal wires in a touch display panel in accordance with Embodiment 7.

### DETAILED DESCRIPTION OF THE INVENTION

The following description is of the contemplated mode of carrying out the disclosure. This description is made for the purpose of illustrating the general principles of the disclosure and should not be taken in a limiting sense. The scope of the disclosure is determined by reference to the appended claims.

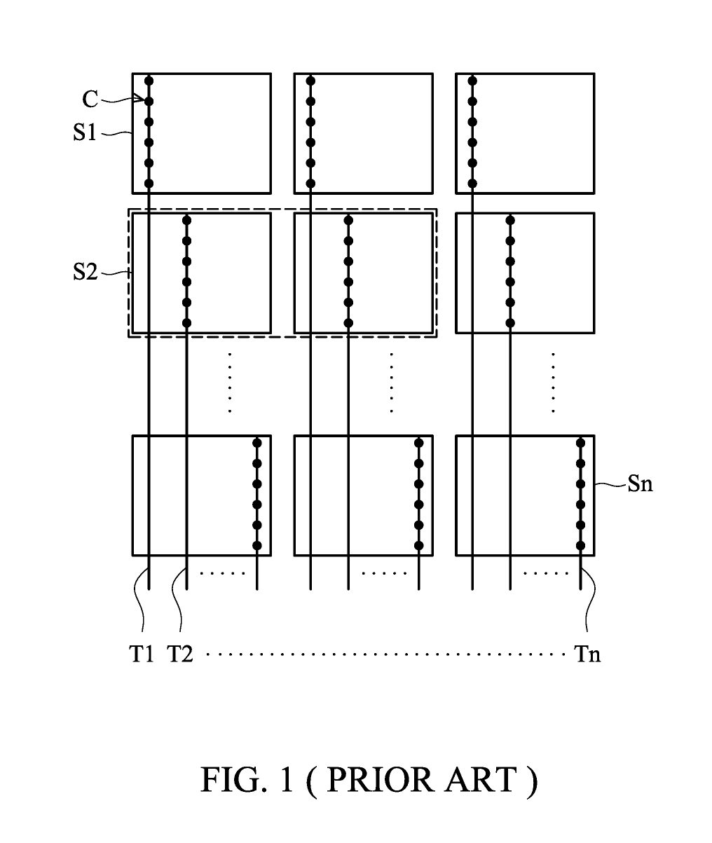

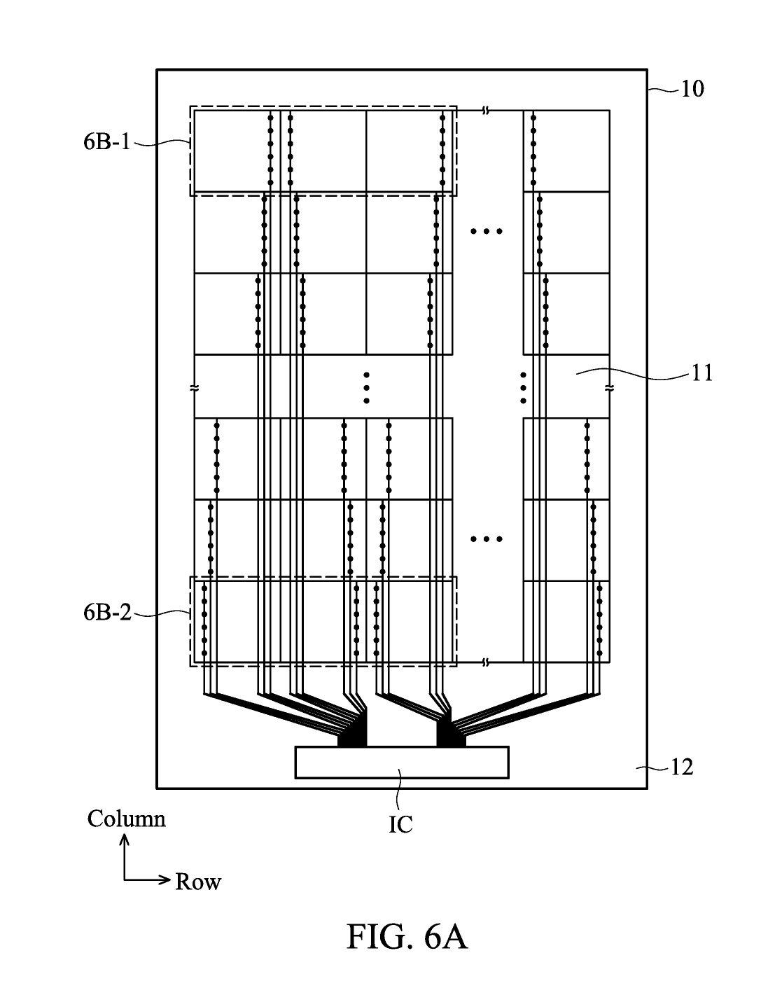

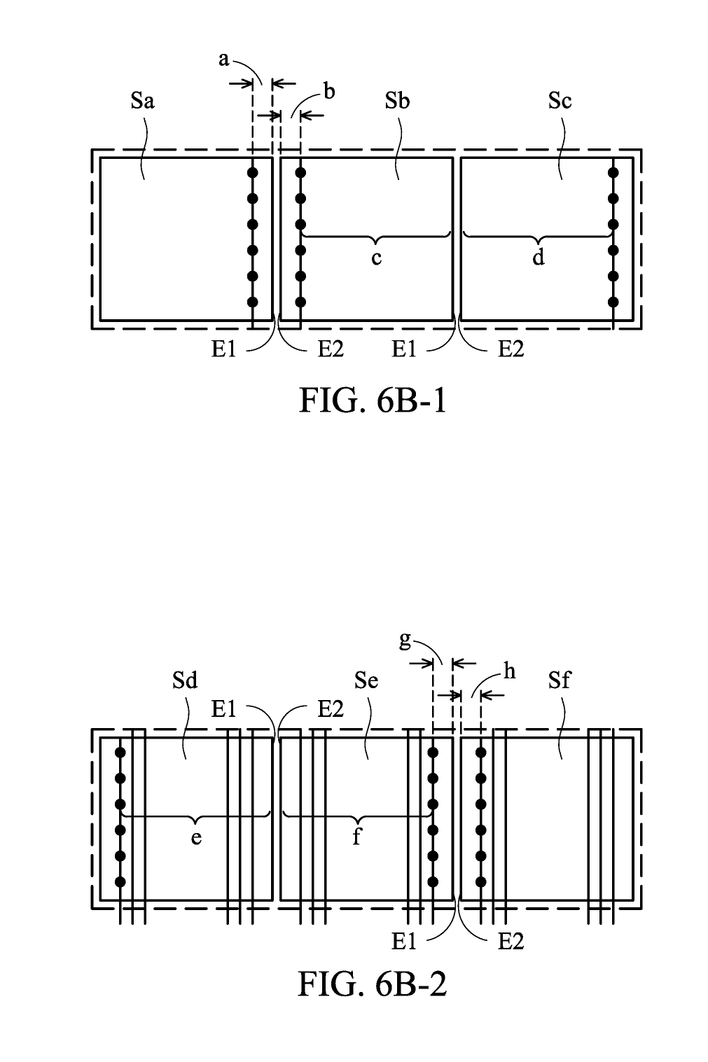

FIG. 6A is a diagram showing a layout of metal wires in a touch display panel in accordance with Embodiment 1. FIGS. 6B-1 and 6B-2 are enlarged views of the portions circled by the dotted line shown in FIG. 6A. In Embodiment 1, from the left side to the right side (or from the right side to the left side) of the substrate, the metal wires disposed in the display area 11 are arranged from the shortest one to the longest one in sequence and then from the longest one to the shortest one in sequence. The metal wire length is increased and decreased alternatively. Under this layout, the distance between the contact hole of either of any two adjacent common electrodes and the boundary of the two adjacent common electrodes is the same. In this embodiment, the row direction corresponds to the first direction recited in the claims, and the column direction corresponds to the second direction recited in the claims.

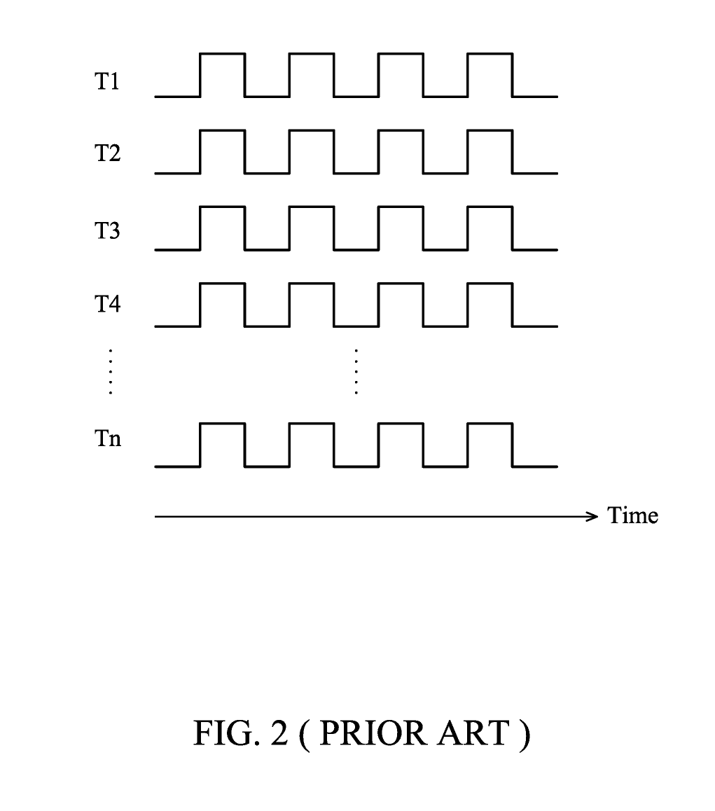

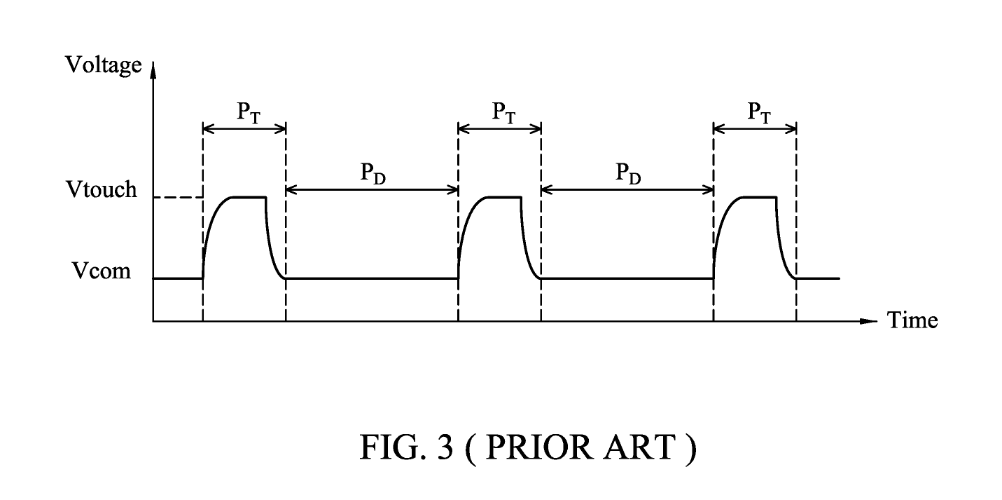

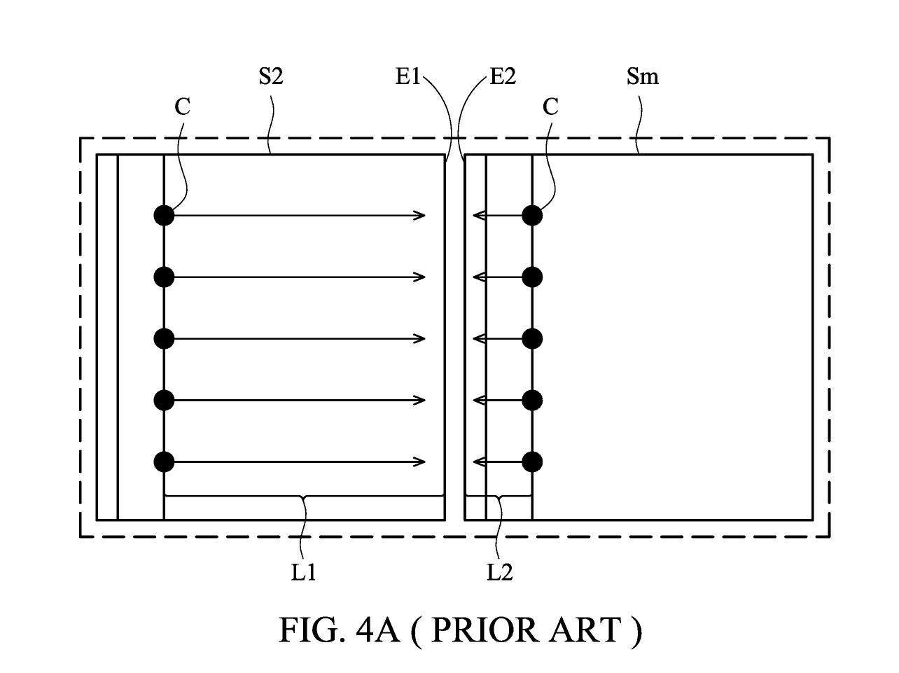

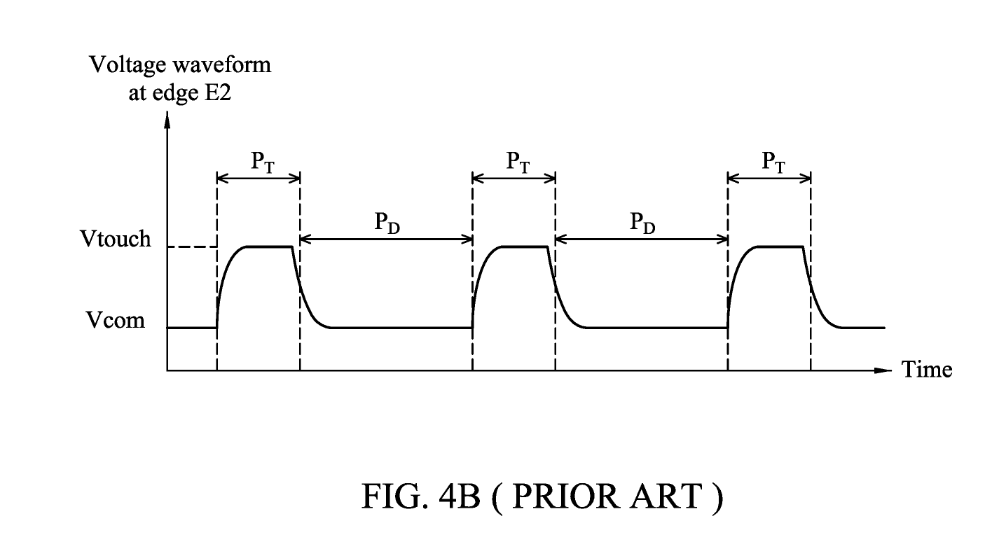

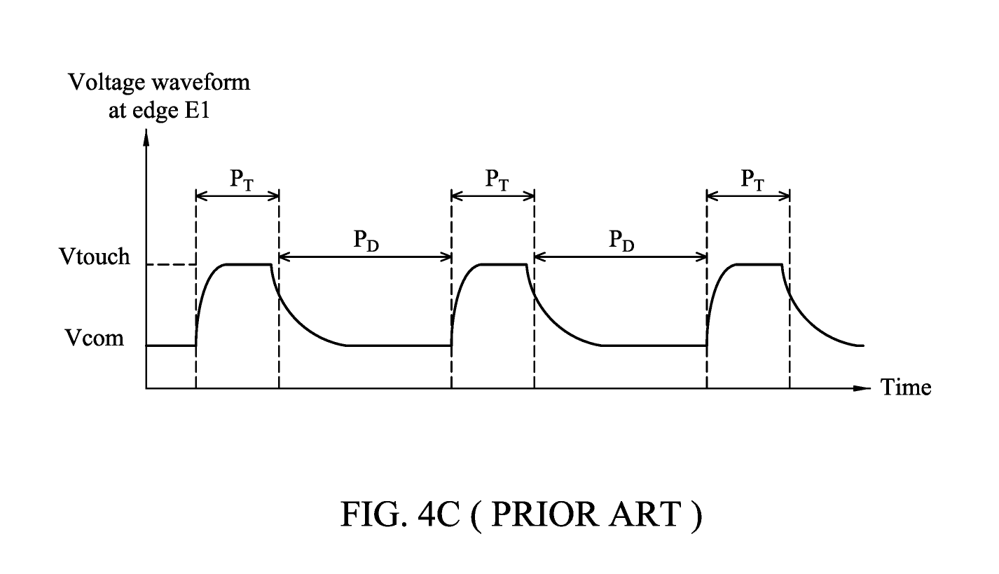

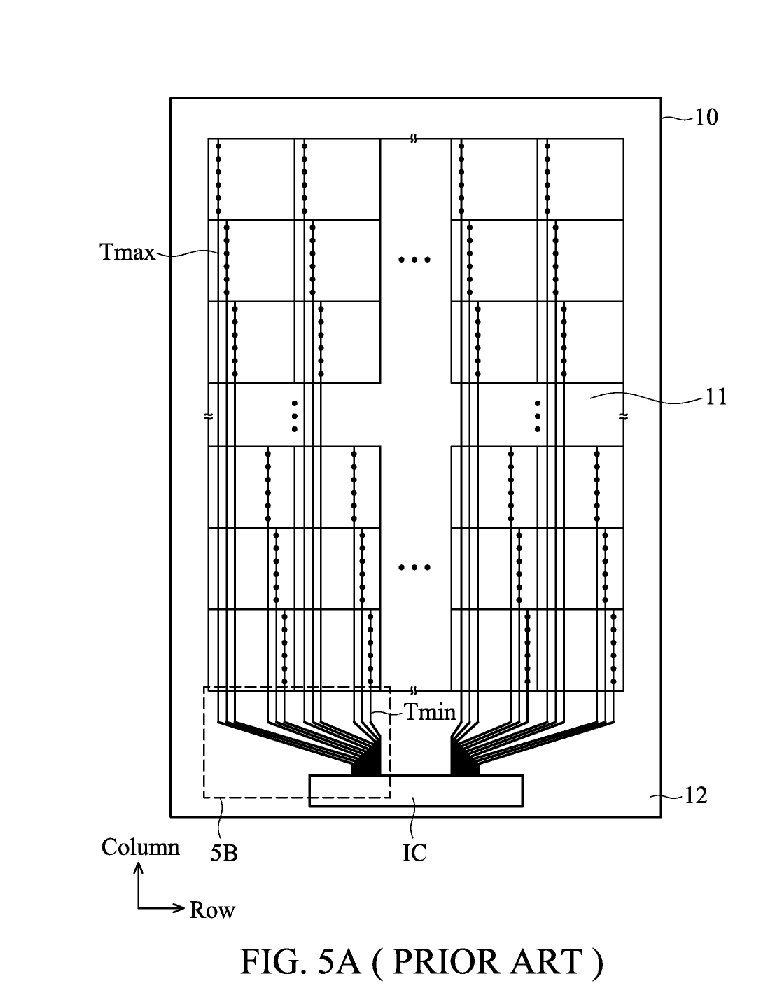

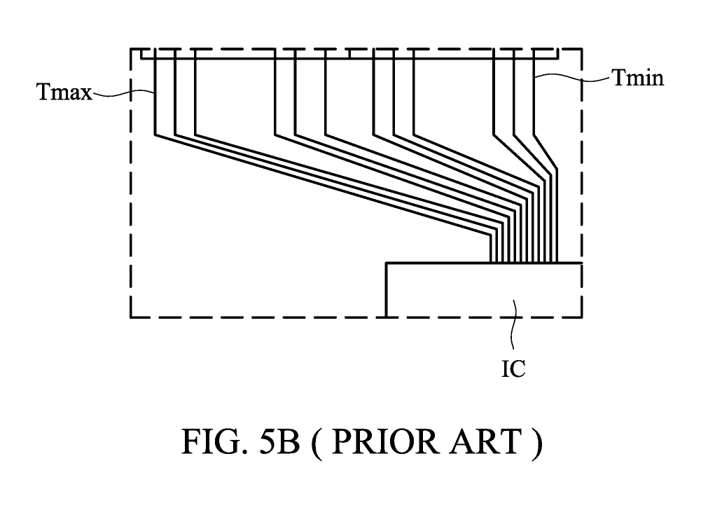

Specifically, as shown in FIG. 6B-1, the three topmost adjacent common electrodes are taken as an example. These three common electrodes, from left to right, are labeled Sa, Sb, and Sc. The edge E1 (corresponding to the first side recited in claims) of the common electrode Sa and the edge E2 (corresponding to the second side recited in claims) of the common electrode Sb are adjacent, and the edge E1 of the common electrode Sb and the edge E2 of the common electrode Sc are adjacent. The shortest distance a between the contact hole and the edge E1 of the common electrode Sa is equal to the shortest distance b between the contact hole and the edge E2 of the common electrode Sb. The shortest distance c between the contact hole and the edge E1 of the common electrode Sb is equal to the shortest distance d between the contact hole and the edge E2 of the common electrode Sc. Similarly, as shown in FIG. 6B-2, the bottommost three adjacent common electrodes are taken as an example. These three common electrodes, from left to right, are labeled Sd, Se, and Sf. The edge E1 of the common electrode Sd and the edge E2 of the common electrode Se are adjacent, and the edge E1 of the common electrode Se and the edge E2 of the common electrode Sf are adjacent. The shortest distance e between the contact hole and the edge E1 of the common electrode Sd is equal to the shortest distance f between the contact hole and the edge E2 of the common electrode Se. The shortest distance g between the contact hole and the edge E1 of the common electrode Se is equal to the shortest distance h between the contact hole and the edge E2 of the common electrode Sf.

In this way, for any two adjacent common electrodes in the row direction, the distance between the contact hole and the adjacent edge of either of the two adjacent common electrodes is the same. Therefore, the difference of the resistance of a signal transmitted via different metal wires to the same boundary is decreased. The display mura can be reduced. In addition, the longest metal wire disposed in the non-display area 12 is connected to the shortest metal wire disposed in the display area 11. Therefore, large RC loading due to a long length of the metal wire can be reduced, and it becomes easy for the metal wire to meet the requirements of RC loading specifications.

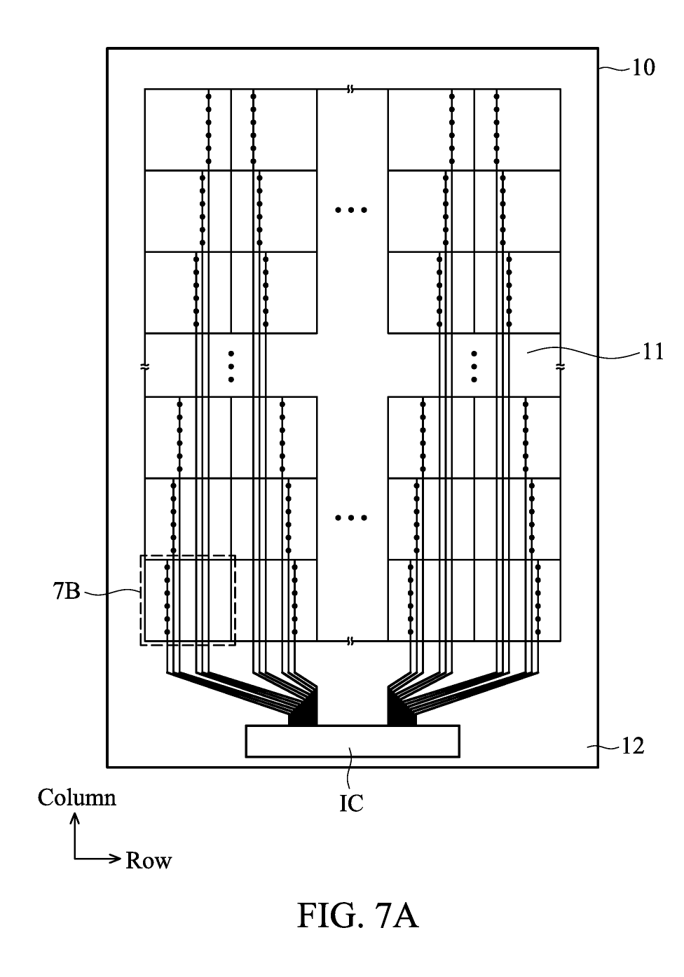

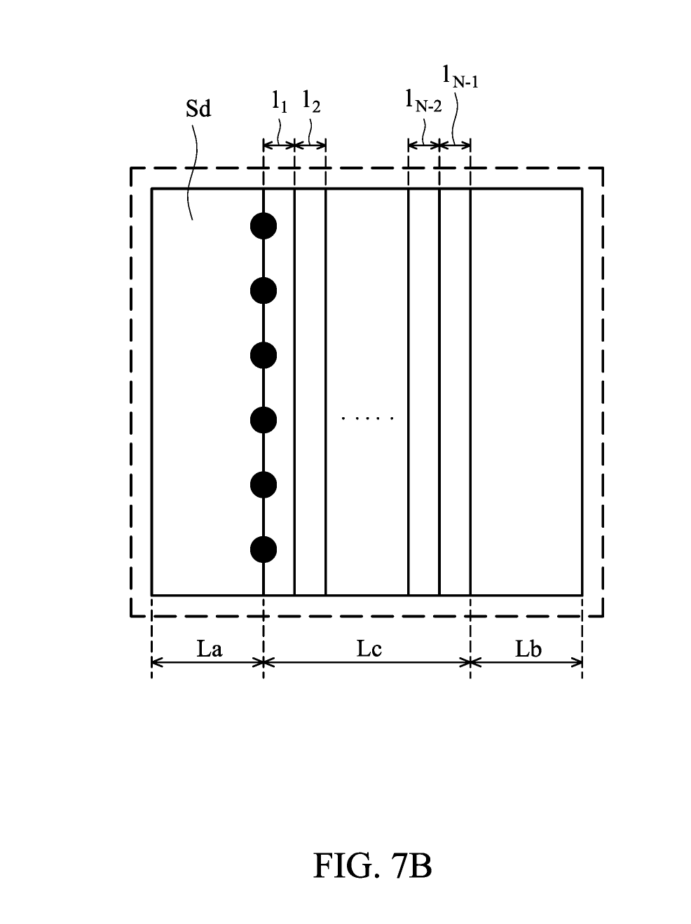

FIG. 7A is a diagram showing a layout of metal wires in a touch display panel in accordance with Embodiment 2. FIGS. 7B is an enlarged views of the portions circled by the dotted line shown in FIG. 7A. In Embodiment 2, the main feature is that the metal wires connected to the common electrodes in the same column are centralized in the middle of the common electrode. In this way, the difference between the distance from a metal wire to the left edge of the common electrode and the distance from the metal wire to the right edge of the common electrode is decreased. In Embodiment 1, as shown in FIG. 6B-1, the common electrode Sb is taken as an example. The distance from the metal wire to the edge E1 is c and the distance from the metal wire to the edge E2 is b. The distance c and the distance b are respectively the longest distance and the shortest distance from a metal wire to an edge of the common electrode. The difference of the distance c and the distance b is so great that the problem of resistance difference also exists on two opposite edge of the same common electrode. However, in Embodiment 2, the metal wires are centralized in the middle of the common electrode. The difference between the distance from a metal wire to the left edge of the common electrode and the distance from the metal wire to the right edge of the common electrode can be decreased to reduce the resistance difference.

Regarding the pattern in which a plurality of metal wires are centralized in the middle of the common electrode, the bottommost common electrode Sd shown in FIG. 7A can be used as an example for explanation. As shown in FIG. 7B, in the region of the common electrode Sd, N metal wires connected to all of the common electrodes arranged in a column cross the common electrode Sd. It is assumed that the distance from the metal wire at the leftmost side to the left edge is La, the distance from the metal wire at the rightmost side to the right edge is Lb, the distance between the metal wire at the leftmost side and the metal wire at the rightmost side is Lc, and the distances between two adjacent metal wires, from left to right, are 1₁, 1₂, . . . , 1_{N-2}, and 1_{N-1}.

In a pattern, the pattern of a plurality of metal wires centralized in the middle of the common electrode means that the distance between any two adjacent metal wires is shorter than the distance from the metal wire at the leftmost side to the left edge, and also shorten than the distance from the metal wire at the rightmost side to the right edge. Namely, 1₁, 1₂, . . . , 1_{N-2}, 1_{N-1}<La, and 1₁, 1₂, . . . , 1_{N-2}, 1_{N-1}<Lb. In another pattern, the pattern of a plurality of metal wires centralized in the middle of the common electrode means that the distance between any two adjacent metal wires is shorter than half of the distance from the metal wire at the leftmost side to the left edge, and also shorten than half of the distance from the metal wire at the rightmost side to the right edge. Namely, 1₁, 1₂, . . . , 1_{N-2}, 1_{N-1}<(½)La, and 1₁, 1₂, . . . , 1_{N-2}, 1_{N-1}<(½)Lb. Furthermore, in another pattern, it is also possible that the average distance between any two adjacent metal wires is shorter than the distance from the metal wire at the leftmost side to the left edge, and also shorter than the distance from the metal wire at the rightmost side to the right edge. The average distance between any two adjacent metal wires is the total span distance of the N metal wires over the number of intervals of adjacent metal wires. Namely, Lc/(N−1)<La, and Lc/(N−1)<Lb. A pattern which meets the requirements of any one of the above three patterns can be considered as an embodiment of centralizing the metal wires in the middle of a common electrode.

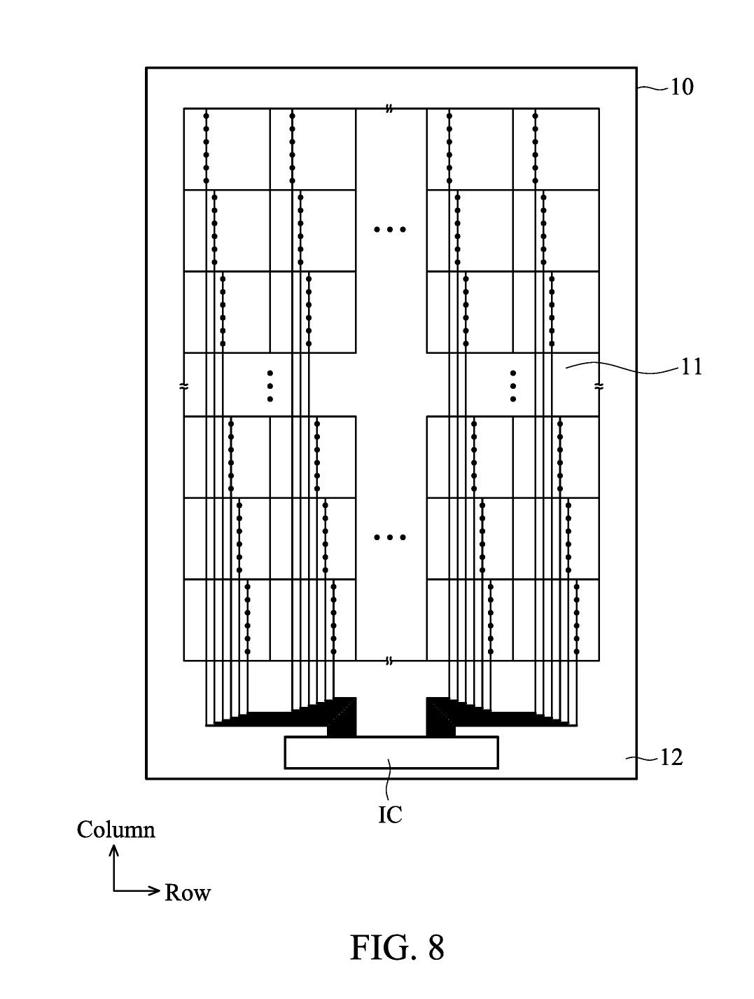

FIG. 8 is a diagram showing a layout of metal wires in a touch display panel in accordance with Embodiment 3. In Embodiment 3, the feature that the metal wires are centralized in the middle of the common electrode is utilized, but the metal wire layout distribution of Embodiment 1 is not utilized. Namely, from the left side to the right side (or from the right side to the left side) of the substrate, the metal wires disposed in the display area 11 are not arranged from the shortest one to the longest one in sequence and then from the longest one to the shortest one in sequence. The distance between the contact hole of either of two adjacent common electrodes in the row direction and the boundary of the two adjacent common electrodes is different. However, because metal wires are centralized in the middle of the common electrode, the influence due to the difference of the distance from the metal wire to the edge of the common electrode can still be reduced to a certain degree.

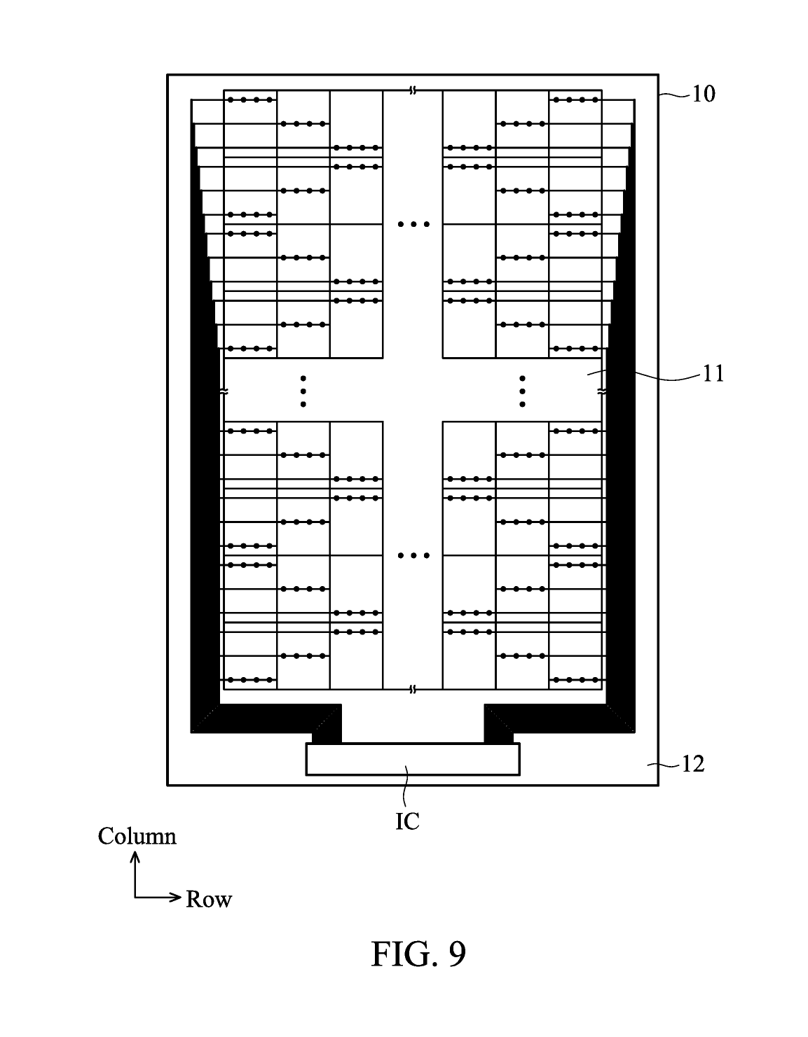

FIG. 9 is a diagram showing a layout of metal wires in a touch display panel in accordance with Embodiment 4. In Embodiments 1-3, the metal wires are arranged parallel to the column direction in the display area 11. However, as shown in FIG. 9, the metal wires can be arranged parallel to the row direction in the display area 11. In this case, the display area 11 can be divided into a left portion and a right portion. The metal wires connected to the common electrodes located in the left portion of the display area 11 extend parallel to the row direction and leave the display area 11 from the left side. Those metal wires then extend along the left edge of the display area 11 in the non-display area 12 until they are connected to the driving chip IC. Similarly, the metal wires connected to the common electrodes located in the right portion of the display area 11 extend parallel to the row direction and leave the display area 11 from the right side. Those metal wires then extend along the right edge of the display area 11 in the non-display area 12 until they are connected to the driving chip IC. The feature of Embodiment 4 is the same as Embodiment 1 only except for the feature that the metal wires are arranged parallel to the row direction in the display area 11. From the top to the bottom (or from the bottom to the top) of the substrate, the metal wires disposed in the display area 11 are arranged from the shortest one to the longest one in sequence and then from the longest one to the shortest one in sequence. The metal wire length is increased and decreased alternatively. Under this layout, the distance between the contact hole of either of any two adjacent common electrodes in the column direction and the boundary of the two adjacent common electrodes is the same. In this embodiment, the column direction corresponds to the first direction recited in claims, the row direction corresponds to the second direction recited in claims, and the two edges of the common electrode parallel to the row direction correspond to the first edge and the second edge recited in claims.

In this way, for any two adjacent common electrodes in the column direction, the distance between the contact hole and the adjacent edge of either of the two adjacent common electrodes is the same. Therefore, the difference of the resistance for a signal transmitted via different metal wires to the same boundary is decreased. The display mura can be reduced. In addition, the longest metal wire disposed in the non-display area 12 is connected to the shortest metal wire disposed in the display area 11. Therefore, large RC loading due to a long length of the metal wire can be reduced, and it becomes easy for the metal wire to meet the requirements of RC loading specifications.

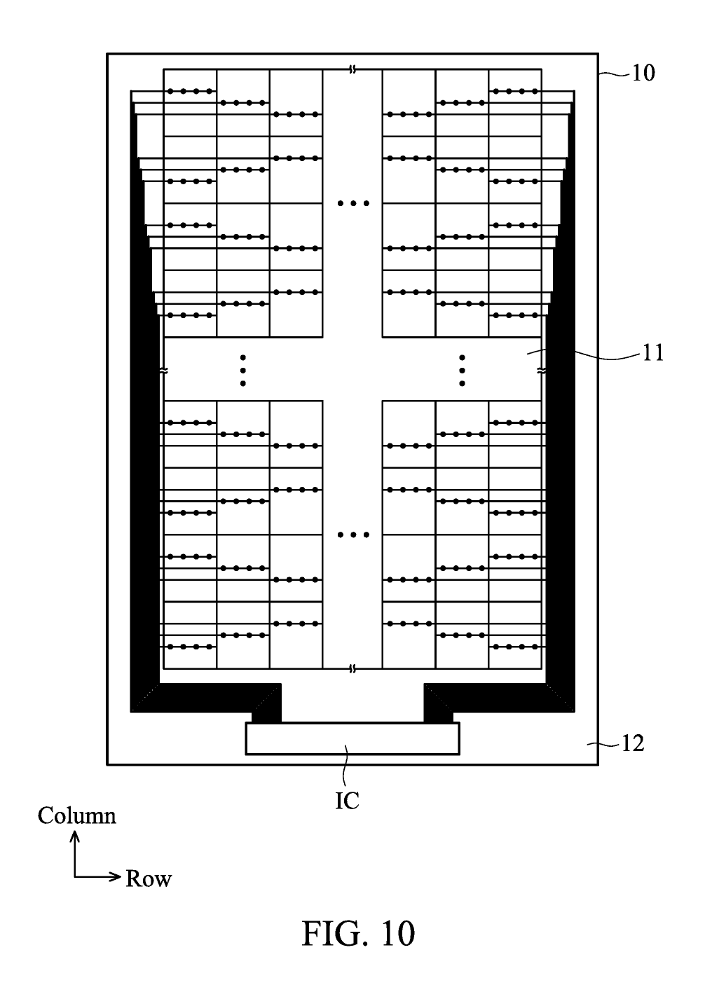

FIG. 10 is a diagram showing a layout of metal wires in a touch display panel in accordance with Embodiment 5. As shown in FIG. 10, the metal wires are arranged parallel to the row direction in the display area 11. However, Embodiment 5 further utilizes the feature that a plurality of the metal wires connected in the common electrodes arranged in the same row are centralized in the middle of the common electrode. Therefore, Embodiment 5 corresponds to a variation of Embodiment 2. Except for the feature that the metal wires are arranged parallel to the row direction in the display area 11, the pattern of centralizing the metal wires in the middle of a common electrode can decrease the difference between the distance from a metal wire to the top edge of the common electrode and the distance from the metal wire to the bottom edge of the common electrode. Therefore, the resistance difference can be reduced.

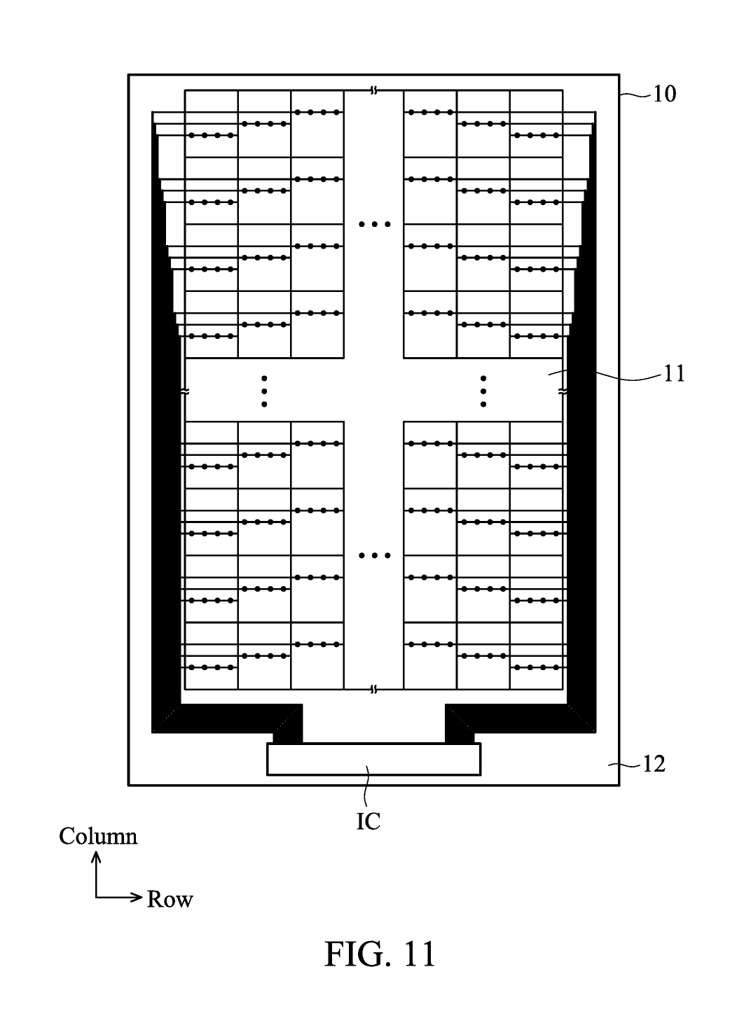

FIG. 11 is a diagram showing a layout of metal wires in a touch display panel in accordance with Embodiment 6. As shown in FIG. 6, the metal wires are arranged parallel to the row direction in the display area 11. Embodiment 6 utilizes the feature that a plurality of the metal wires are centralized in the middle of the common electrode as Embodiment 5. However, Embodiment 6 doesn't utilize the metal wire layout of Embodiment 4 or 5. That is to say, from the top to the bottom (or from the bottom to the top) of the substrate, the metal wires disposed in the display area 11 are not arranged from the shortest one to the longest one in sequence and then from the longest one to the shortest one in sequence. The distance between the contact hole of either of any two adjacent common electrodes in the column direction and the boundary of the two adjacent common electrodes is different. However, because metal wires are centralized in the middle of the common electrode, the influence due to the difference of the distance from the metal wire to the edge of the common electrode can still be reduced to a certain degree.

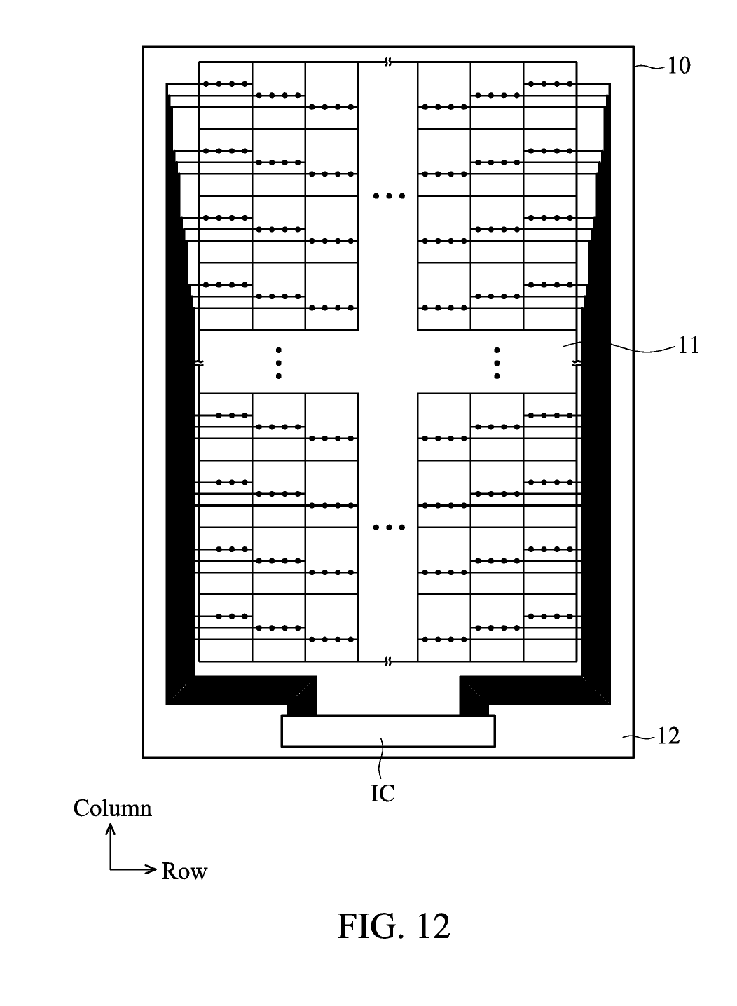

FIG. 12 is a diagram showing a layout of metal wires in a touch display panel in accordance with Embodiment 7. As shown in FIG. 12, the metal wires are arranged parallel to the row direction in the display area 11. Embodiment 7 utilizes the feature that a plurality of the metal wires are centralized in the middle of the common electrode as Embodiment 6. However, Embodiment 7 doesn't utilize the metal wire layout of Embodiment 4 or 5. Embodiment 7 is different form Embodiment in that the longest metal wire disposed in the non-display area 12 is connected to the shortest metal wire disposed in the display area 11. Therefore, large RC loading due to a long length of metal wire can be reduced, and it becomes easy for the metal wire to meet the requirements of RC loading specifications.

According to the metal wire layouts on the touch display panel of Embodiments 1-7, the distance between the contact hole and the adjacent edge of either of the two adjacent common electrodes is made the same. Therefore, the display mura can be reduced. In addition, the longest metal wire disposed in the non-display area 12 can be connected to the shortest metal wire disposed in the display area 11 to lower RC loading of the metal wire. Furthermore, the metal wires can be centralized in the middle of a common electrode to decrease the resistance difference from a metal wire to the two opposite edges of the common electrode.

On the other hand, the disclosure adopts a fringe field switching (FFS) type structure in which the pixel electrodes and the common electrodes are arranged on the same substrate. This structure includes a top pixel type structure (the pixel electrodes is located in an upper layer that is close to the liquid-crystal layer and the common electrodes is located in an lower layer that is close to the thin-film transistor layer) and a top com type structure (the common electrodes is located in an upper layer that is close to the liquid-crystal layer and the pixel electrodes is located in an lower layer that is close to the thin-film transistor layer).

While the disclosure has been described by way of example and in terms of the embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch display panel, comprising:
a substrate having a display area and a non-display area surrounding the display area;
a plurality of common electrodes arranged in the display area in a first direction and a second direction that is different from the first direction;
a driving chip arranged in the non-display area; and
a plurality of metal wires connected to the common electrodes and the driving chip,
wherein the metal wires extend parallel to the second direction in the display area,
at least one of the common electrodes is connected with one of the metal wires via at least a contact hole,
the common electrodes comprise a first common electrode and a second common electrode that is adjacent in the first direction, and both the first common electrode and the second common electrode have a first side and a second side that are parallel to the second direction, and
the second side of the first common electrode and the first side of the second common electrode are adjacent, and a distance between the contact hole of the first common electrode and the second side of the first common electrode is equal to a distance between the contact hole of the second common electrode and the first side of the second common electrode.

2. The touch display panel as claimed in claim 1, wherein regarding the common electrodes having the same position in the first direction, a distance between any two adjacent metal wires is shorter than a distance between the metal wire nearest to the first side and the first side, and shorter than a distance between the metal wire nearest to the second side and the second side.

3. The touch display panel as claimed in claim 1, wherein regarding the common electrodes having the same position in the first direction, a distance between any two adjacent metal wires is shorter than half of a distance between the metal wire nearest to the first side and the first side, and shorter than half of a distance between the metal wire nearest to the second side and the second side.

4. The touch display panel as claimed in claim 1, wherein assuming that there are N of the metal wires connected to the common electrodes having the same position in the first direction, a distance between the metal wire nearest to the first side and the first side is La, a distance between the metal wire nearest to the second side and the second side is Lb, and the span width of the N metal wires in the first direction is Lc, the following equation is satisfied:
Lc/(N−1)<La;
and
Lc/(N−1)<Lb.

5. The touch display panel as claimed in claim 1, wherein regarding the metal wires connected to the common electrodes having the same position in the first direction, one having longer length in the display area has a shorter length in the non-display area, and one having a shorter length in the display area has a longer length in the non-display area.

6. The touch display panel as claimed in claim 1, wherein the first direction is one of the row direction and the column direction in a matrix, and the second direction is the other of the row direction and the column direction in the matrix.

7. A touch display panel, comprising:
a substrate having a display area and a non-display area surrounding the display area;
a plurality of common electrodes arranged in the display area in a first direction and a second direction that is different from the first direction, at least one of the common electrodes having a first side and a second side parallel to the second direction;
a driving chip arranged in the non-display area; and
a plurality of metal wires connected to the common electrodes and the driving chip,
wherein the metal wires extend parallel to the second direction in the display area,
at least one of the common electrodes is connected with one of the metal wires via at least a contact hole, and
regarding the common electrodes having the same position in the first direction, a distance between any two adjacent metal wires is shorter than a distance between the metal wire nearest to the first side and the first side, and the distance between any two adjacent metal wires is shorter than a distance between the metal wire nearest to the second side and the second side.

8. The touch display panel as claimed in claim 7, wherein regarding the common electrodes having the same position in the first direction, a distance between any two adjacent metal wires is shorter than half of a distance between the metal wire nearest to the first side and the first side, and the distance between any two adjacent metal wires is shorter than half of a distance between the metal wire nearest to the second side and the second side.

9. The touch display panel as claimed in claim 7, wherein regarding the metal wires connected to the common electrodes having the same position in the first direction, one having longer length in the display area has a shorter length in the non-display area, and one having a shorter length in the

10. The touch display panel as claimed in claim 7, wherein the first direction is one of the row direction and the column direction in a matrix, and the second direction is the other of the row direction and the column direction in the matrix.
